(19) United States
(12) Patent Application Publication
(10) Pub. No.: US 2010/0299345 A1
(43) Pub. Date: Nov. 25, 2010

(54) Method for Serving Search Content by a Soap Operation

(76) Inventors: Jong Sul Lee, Gyeonggi-do (KR); Seok Pil Lee, Gyeonggi-do (KR); Tae Bum Lim, Gyeonggi-do (KR); Kyoung Ro Yoon, Seoul (KR); Saim Shin, Seoul (KR)

Correspondence Address: Andrew F. Bodendorf, P.O. BOX 34688, WASHINGTON, DC, 20043, US

(21) Appl. No.: 12/307,156

(22) PCT Filed: Sep. 2, 2008
(86) PCT No.: PCT/KR08/05140

§ 371 Date: Jul. 16, 2010

(30) Foreign Application Priority Data
Sep. 3, 2007 (KR) 10-2007-0088758

(51) Int. Cl. G06F 17/30

(52) U.S. Cl. 707/769; 707/E17.014

(57) ABSTRACT

Provided is a method for servicing queried contents using a Simple Object Access Protocol (SOAP) operation. The method includes transmitting a request message of a SOAP query operation to which a request element field type is added in order to request various content searches through a complex operation, and extracting a query result expression value corresponding to a table field designated in the request field type element, and adding the extracted query expression value to a query result element to transmit the added value by a response message of the SOAP operation, when the request message includes the request element field type designating a query request result value. The method sorts and/or groups the query results of contents according to the extraction order of queried contents by adding operators associated with an arithmetic operation and/or a comparison operation to a query request field of a SOAP query operation upon query request of contents, thereby servicing the more various accurate query results of contents. Accordingly, the method services the more various accurate query results of contents on the basis of users preference information to users, thereby increasing convenience for users.

### CROSS REFERENCE TO RELATED APPLICATIONS

This patent application claims priority to international patent application PCT/KR2008/005140 filed on Sep. 2, 2008, and Korean patent application 10-2007-88758 filed on Sep. 3, 2007, which are incorporated by reference herein.

### BACKGROUND OF THE INVENTION

The present disclosure relates to a contents providing service, and in particular, to a method for servicing queried contents using a Simple Object Access Protocol (SOAP) operation.

Recently, due to the full-scale providing of a digital broadcast service, studies have been made on a technology for providing a custom broadcast service in multi-channel and multi-medium environments. As an example, TV-Anytime being nongovernmental global standard is a standard protocol for providing an Anytime service that enables users to store desired contents and to view the stored contents by matching user's preference information with metadata on the basis of the metadata representing the description information of contents.

As described above, the metadata are the description information of contents. In the TV-Anytime, the metadata include a content-based description and Electronic Program Guide (EPG) information defined in MPEG-7, and enable users to easily search and select desired contents. A metadata standard is configured with two parts. A part A defines a format for describing the metadata, i.e., a schema, and uses eXtensible Markup Language (XML) based MPEG-7 Description Definition Language (DDL) (ISO/IEC 15938-2). A part B relates to the transmission of the metadata, and includes Binary Format for MPEG-7 (ISO/IEC 15938-1), fragmentation model, encapsulation and indexing schemes.

FIG. 1 illustrates a configuration of a general TV-Anytime metadata. The general TV-Anytime metadata include program description metadata and user description metadata, wherein the program description metadata are configured with content description metadata and instance description metadata. The metadata for one program are a content identifier called Content Reference Identifier (CRID) and are interconnected.

The content description metadata are generated by a content creator, and include a program title, a genre, an abstract, a critic review and the like. The instance description metadata are generated by a content provider, and include a location (broadcast time, channel, Uniform Resource Locator (URL) and the like), a use rule, a delivery parameter and the like. The user description metadata include a user preference, a usage history, a personal bookmark and the like, and are generated by a user.

The TV-Anytime standard defines two types of metadata web services for providing interactive metadata service through a return path, wherein each of the metadata web services is a well-defined behavior and a remote procedure for an input/output set. In XML based Web Service Description Language (WSDL), the remote procedure is defined as a SOAP operation type, and includes a get_Data operation for the search of the metadata and a submit_Data operation for a user description submission. For example, the above-described SOAP protocol is an XML communication protocol enabling to access to objects in a distributed environment.

A request/response type used in a TV-Anytime metadata service is defined in a name space of “urn:tva:transport:2002” wherein the name space is provided as a tool for the verification of various messages. Types defined in a metadata spec and a content referencing standard are referred to in a transport name space. A schema fragment is defined in the name space, and a name space provider is defined as “tns:”?in the schema fragment. A complete XML schema file is tva_transport_types_v10.xsd.

1. get_Data Operation

The get_Data operation provides a function that enables clients to search TV-Anytime data on a program or a program group from a server. Examples of functions that a TV-Anytime metadata provider can provide using the get-Data operation are as follows.
Return content referencing data of the CRID using a CRID list.
Return the TV-Anytime metadata of the CRID using the CRID list.
Receive a query of a specific metadata attribute (for example, a genre, an actor and the like), and return a program corresponding to the received query.
Respond to a query for a specific time or a specific channel, and return a corresponding program.

The get_Data operation supports all query types in principle, and provides a wide scope of query on a metadata limitation condition.

A. Request Format

Referring to FIGS. 2 to 4, in the get_Data operation, the request format designates three types of parameters to clients and designates an element type returned as a result value of a query (search) to a RequestedTables type.

B. Response Format

Referring to FIG. 5, the response format of the get_Data operation include 0 or at least one XML instance document on elements (TVAMain, ContentReferencingTable, InvalidFragments), and returns a query result value according to the RequestedTables type requested by the request format.

As described above, upon request of a search query, the TV-Anytime operation which is defined at present performs the comparison search of a character string on a field value such as a specific element and a specific attribute on which a search is desired.

A related art metadata providing method using the SOAP operation is a method that searches contents according to titles or genres with the fundamental search type and structure of the metadata (for example, a text comparison on a specific field value). However, since a type for representing various output descriptions is not defined, the related art metadata providing method cannot service query contents corresponding to various queries.

### SUMMARY OF THE INVENTION

Therefore, an object of the present disclosure is to provide a method for serving search content by a SOAP operation, which can aggregately process and service a search result of corresponding contents when a specific content query is requested by a SOAP query operation.

Another object of the present disclosure is to provide a method for serving search content by a SOAP operation, which sorts and groups the query results of corresponding contents satisfying a complex operation result using a comparison operation and/or an arithmetic operator in a SOAP query operation, thereby servicing the sorted and grouped query results.

According to an aspect, there is provided a method for servicing search content by a Simple Object Access Protocol (SOAP) operation, the method including: transmitting a request message of a SOAP query operation to which a request element field type is added in order to request various content searches through a complex operation; and extracting a query result expression value corresponding to a table field designated in the request field type element, and adding the extracted query expression value to a query result element to transmit the added value by a response message of the SOAP operation, when the request message includes the request element field type designating a query request result value.

The response message may include at least one query result element of maxPage, maxItem, freeText, resource, outputName, Field, AggregateID, FieldCombination, SortBy, GroupBy, GroupByField, Aggregate, Thumbnail and typeName.

The response message may sort and/or group query results according to query-requesting contents.

The complex operation may be a specific operation which enables to express a query result by expressing a high-level query contents.

According to another aspect, there is provided a computer-readable storage medium storing a command which performs each operation of a method for servicing search content by a SOAP operation.

### BRIEF DESCRIPTION OF THE DRAWINGS

FIG. 1 is a block diagram of a general TV-Anytime metadata.

FIGS. 2 to 4 are exemplary diagrams illustrating a related art request format of the get_Data operation.

FIG. 5 is an exemplary diagram illustrating a related art response format of the get_Data operation.

FIG. 6 illustrates a concept of a metadata distribution operation according to an exemplary embodiment.

FIG. 7 is an exemplary diagram illustrating a constant value type applied to an exemplary embodiment.

FIGS. 8 to 11 are exemplary diagrams illustrating a field combination type applied to an exemplary embodiment.

FIGS. 12 to 14 are exemplary diagrams illustrating a comparison type applied to an exemplary embodiment.

FIG. 15 is an exemplary diagram illustrating a response message type of a SOAP operation according to an exemplary embodiment.

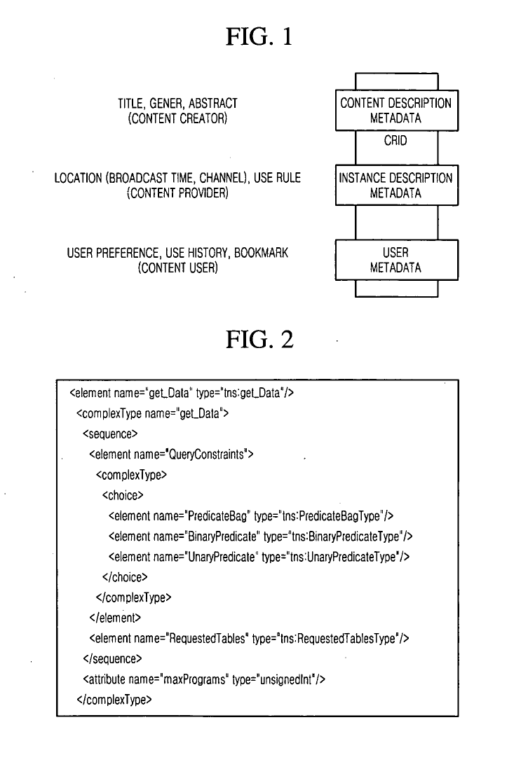

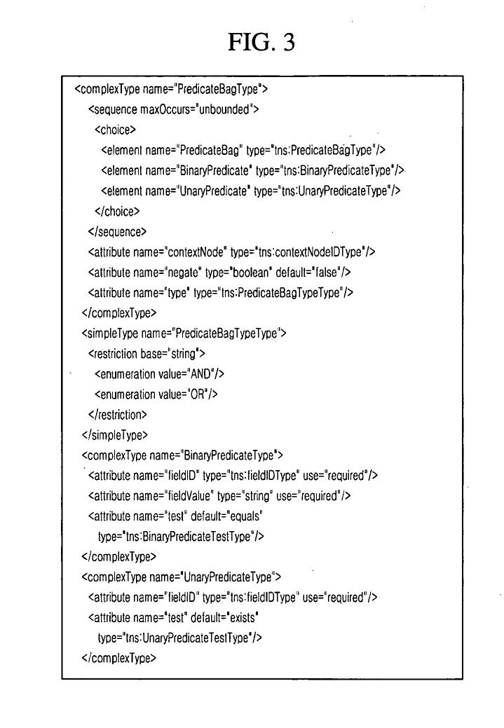

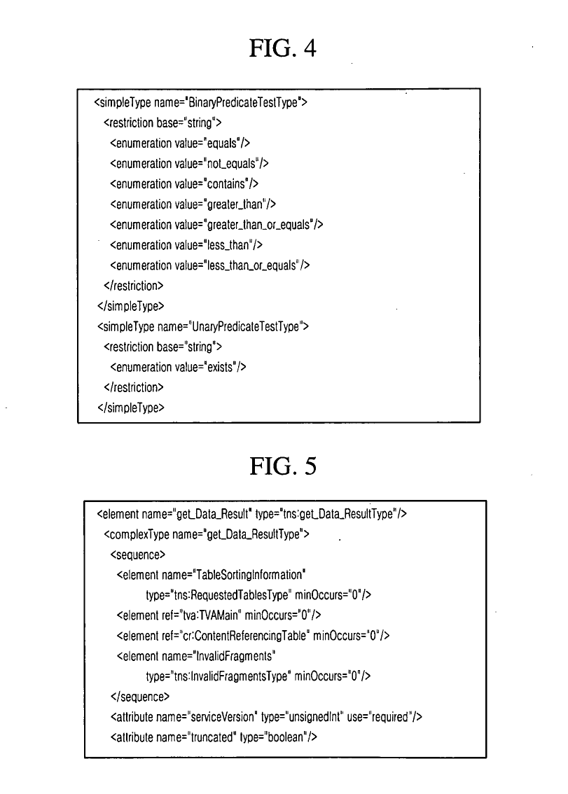

### DETAILED DESCRIPTION OF PREFERRED EMBODIMENTS

A method for serving search content by a SOAP operation according to an exemplary embodiment has a technical point that sorts and groups the query results of query-requesting contents by a SOAP query operation, thereby servicing query contents. The method according to an exemplary embodiment adds a request element field type to the SOAP query operation in order to request various content searches through an arithmetic operation and/or a comparison operation. Therefore, the method according to an exemplary embodiment adds a query result element of a type extended to a query result field to a SOAP response message according to the SOAP query operation to which the request element field type is added, thereby servicing query contents which are aggregately processed on query results.

In this specification, a complex operation is defined as that it denotes an operation enabling to express high-level query contents.

Hereinafter, specific embodiments will be described in detail with reference to the accompanying drawings. In description below, the specific details of a method for serving search content by a SOAP operation according to the present invention are described for providing the more overall understanding of the present invention. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

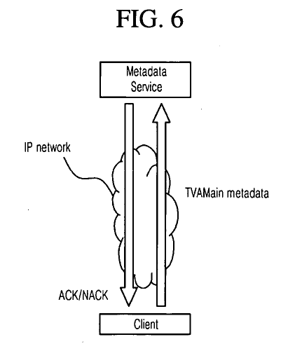

FIG. 6 illustrates a concept of a metadata distribution operation according to an exemplary embodiment.

In a TV-Anytime service, a client transmits a SOAP request message [get_Data( ) Request] by a get_Data operation to a metadata service server through the Internet network (IP Network). At this point, the get_Data operation supports all query types in principle, and provides a wide scope of query on a metadata limitation condition.

In particular, a request element field type is added to a specific field of the get_Data operation through an intrinsic operation of a comparison operation in order to express a complex operation. Then, the metadata service server sorts and/or groups metadata corresponding to a query result value of the SOAP request message to which the request element field type is added by a query result field of a SOAP response message [get_Data( )Response], and returns the sorted and/or grouped metadata.

Upon content query, to sort and/or group a query result value and return the sorted and/or grouped query result value, the request element field of the SOAP query operation must be added in order to query contents through a complex operation (an arithmetic operation and/or a comparison operation).

A case will be described in detail below in which the request element field type is added in order to request various content searches through an arithmetic operation in a SOAP query operation.

1. Constant Value

A constant value type is a type that is defined for allotting an operand of an arithmetic operation as a constant. The constant value type defines all types associated with the arithmetic operation as optional elements in a MPEG-7 and XML based type, and includes the defined elements.

Upon application of an operator, any one of type elements emerging in the constant value type is selected as an operand type so that it includes an operand value and type information. One type is selected from a ConstantValue type, and thus it is possible to immediately check the types of operands under use of the operands for a right operation.

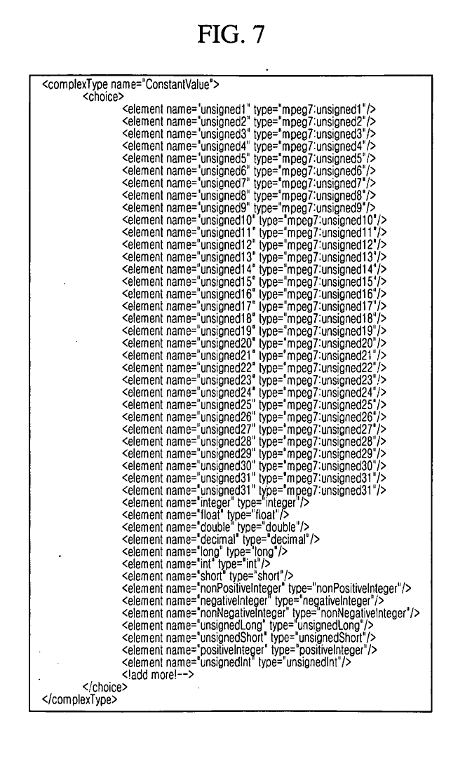

Such a constant value type is expressed as illustrated in FIG. 7, and arithmetic operand types are defined as described in Table 1 below.

TABLE 1

| Name | Definition |
|---|---|
| ConstantValueType | This type selectively includes types capable of being used as |
| | operands in a FieldCombinationType type and a |
| | ComprarisonOperandType type, and thus is described and defined. |
| Unsigned 1 | This element represents that a corresponding operand type is |
| | an unsigned 1 in a MPEG-7 based data type. |
| Unsigned 2 | This element represents that a corresponding operand type is |
| | an unsigned 2 in a MPEG-7 based data type. |
| Unsigned 3 | This element represents that a corresponding operand type is |
| | an unsigned 3 in a MPEG-7 based data type. |
| Unsigned 4 | This element represents that a corresponding operand type is |
| | an unsigned 4 in a MPEG-7 based data type. |
| Unsigned 5 | This element represents that a corresponding operand type is |
| | an unsigned 5 in a MPEG-7 based data type. |
| Unsigned 6 | This element represents that a corresponding operand type is |
| | an unsigned 6 in a MPEG-7 based data type. |
| Unsigned 7 | This element represents that a corresponding operand type is |
| | an unsigned 7 in a MPEG-7 based data type. |
| Unsigned 8 | This element represents that a corresponding operand type is |
| | an unsigned 8 in a MPEG-7 based data type. |
| Unsigned 9 | This element represents that a corresponding operand type is |
| | an unsigned 9 in a MPEG-7 based data type. |
| Unsigned 10 | This element represents that a corresponding operand type is |
| | an unsigned 10 in a MPEG-7 based data type. |
| Unsigned 11 | This element represents that a corresponding operand type is |
| | an unsigned 11 in a MPEG-7 based data type. |
| Unsigned 12 | This element represents that a corresponding operand type is |
| | an unsigned 12 in a MPEG-7 based data type. |
| Unsigned 13 | This element represents that a corresponding operand type is |
| | an unsigned 13 in a MPEG-7 based data type. |
| Unsigned 14 | This element represents that a corresponding operand type is |
| | an unsigned 14 in a MPEG-7 based data type. |
| Unsigned 15 | This element represents that a corresponding operand type is |
| | an unsigned 15 in a MPEG-7 based data type. |
| Unsigned 16 | This element represents that a corresponding operand type is |
| | an unsigned 16 in a MPEG-7 based data type. |
| Unsigned 17 | This element represents that a corresponding operand type is |
| | an unsigned 17 in a MPEG-7 based data type. |
| Unsigned 18 | This element represents that a corresponding operand type is |
| | an unsigned 18 in a MPEG-7 based data type. |
| Unsigned 19 | This element represents that a corresponding operand type is |
| | an unsigned 19 in a MPEG-7 based data type. |
| Unsigned 20 | This element represents that a corresponding operand type is |
| | an unsigned 20 in a MPEG-7 based data type. |
| Unsigned 21 | This element represents that a corresponding operand type is |
| | an unsigned 21 in a MPEG-7 based data type. |
| Unsigned 22 | This element represents that a corresponding operand type is |
| | an unsigned 22 in a MPEG-7 based data type. |
| Unsigned 23 | This element represents that a corresponding operand type is |
| | an unsigned 23 in a MPEG-7 based data type. |
| Unsigned 24 | This element represents that a corresponding operand type is |
| | an unsigned 24 in a MPEG-7 based data type. |
| Unsigned 25 | This element represents that a corresponding operand type is |
| | an unsigned 25 in a MPEG-7 based data type. |
| Unsigned 26 | This element represents that a corresponding operand type is |
| | an unsigned 26 in a MPEG-7 based data type. |
| Unsigned 27 | This element represents that a corresponding operand type is |
| | an unsigned 27 in a MPEG-7 based data type. |
| Unsigned 28 | This element represents that a corresponding operand type is |
| | an unsigned 28 in a MPEG-7 based data type. |
| Unsigned 29 | This element represents that a corresponding operand type is |
| | an unsigned 29 in a MPEG-7 based data type. |
| Unsigned 30 | This element represents that a corresponding operand type is |
| | an unsigned 30 in a MPEG-7 based data type. |
| Unsigned 31 | This element represents that a corresponding operand type is |
| | an unsigned 31 in a MPEG-7 based data type. |
| Unsigned 32 | This element represents that a corresponding operand type is |
| | an unsigned 32 in a MPEG-7 based data type. |
| Integer | This element represents that a corresponding operand type is |
| | an integer in a MPEG-7 based data type. |
| Float | This element represents that a corresponding operand type is a |
| | float in a MPEG-7 based data type. |
| Double | This element represents that a corresponding operand type is a |
| | double in a MPEG-7 based data type. |
| Decimal | This element represents that a corresponding operand type is a |
| | decimal in a MPEG-7 based data type. |
| Long | This element represents that a corresponding operand type is a |
| | long in a MPEG-7 based data type. |
| Int | This element represents that a corresponding operand type is |
| | an Int in a MPEG-7 based data type. |
| Short | This element represents that a corresponding operand type is a |
| | short in a MPEG-7 based data type. |
| nonPositiveInteger | This element represents that a corresponding operand type is a |
| | nonPositiveInteger in a MPEG-7 based data type. |

2. Arithmetic Operators

A content information extracting process requires the definition of operators carrying arithmetic values for clarification of an extraction condition as well as the generation of an extraction result. Therefore, a content query type also requires the definition of the following important arithmetic operators.
Field Combination

A field combination type is defined as a parent class of all operators carrying arithmetic values. All arithmetic operators must succeed to FieldCombination as an abstract type. Moreover, the arithmetic operators must carry result values after each operation.

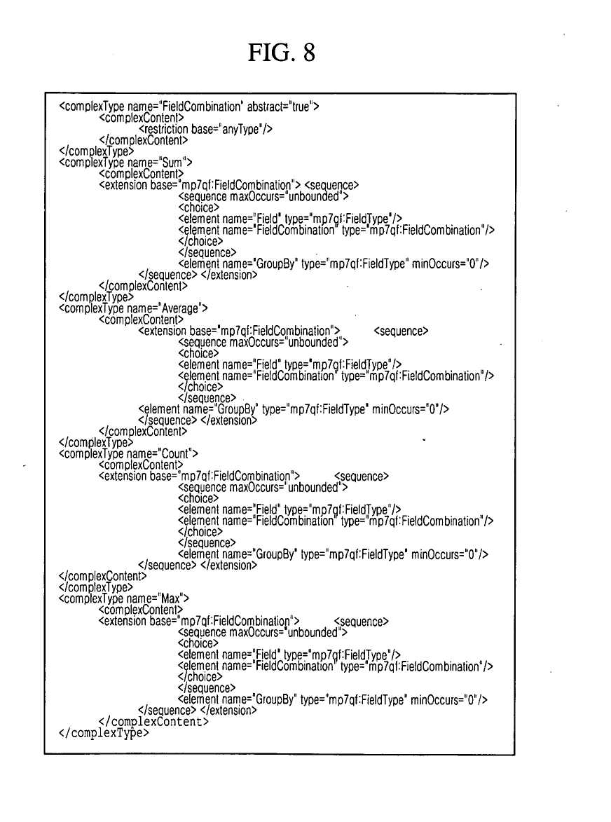

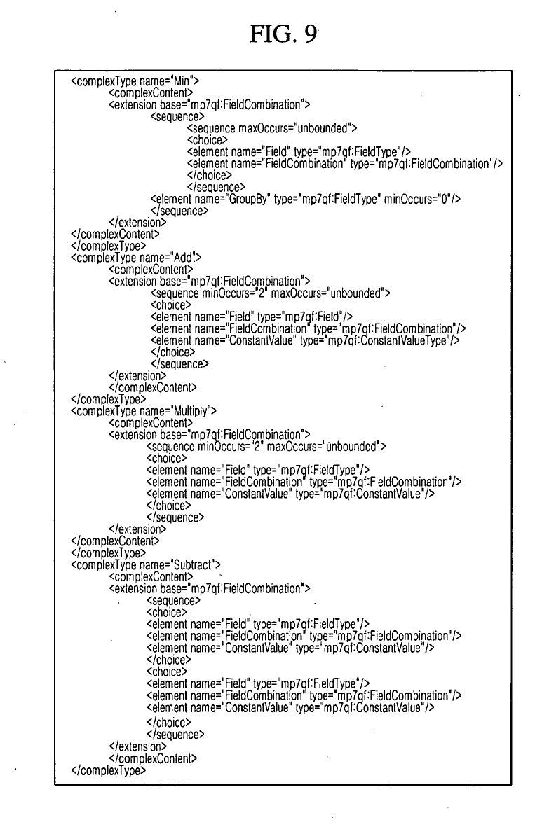

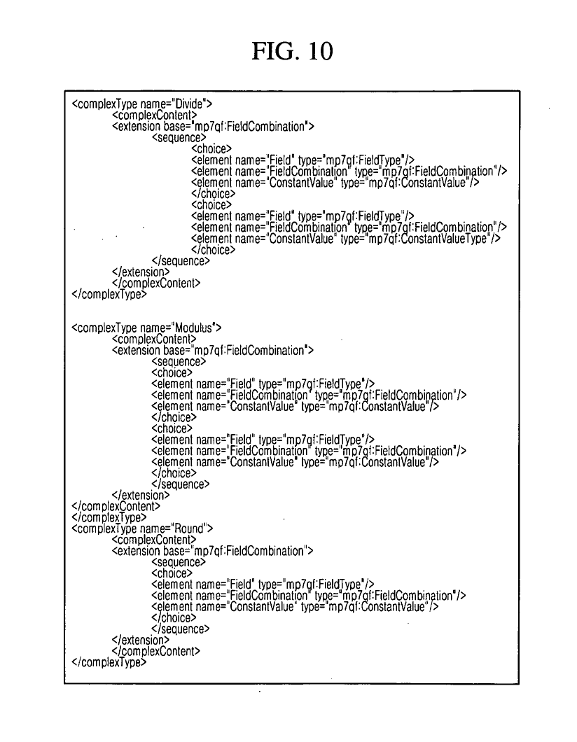

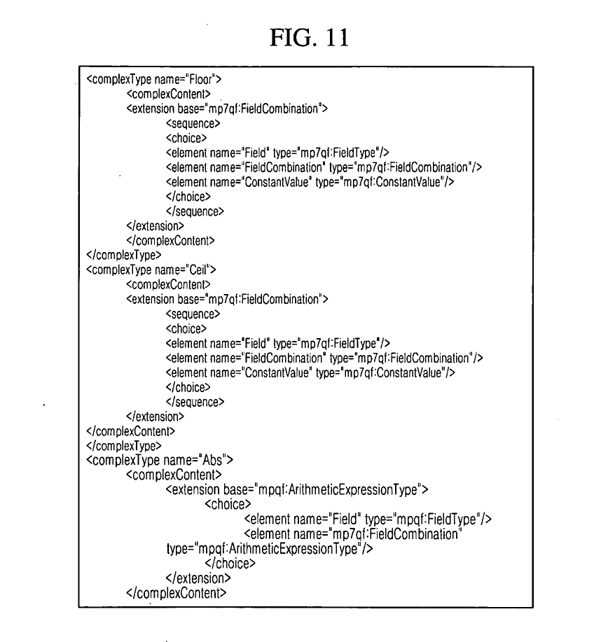

Such a field combination type is expressed as illustrated in FIGS. 8 to 11, and defines the arithmetic operator types expressed in the following Table 2 for applying to a query type.

TABLE 2

| Name | Definition |
|---|---|
| FieldCombination | FieldCombination is a base type for defining arithmetic |
| | operators. |
| Sum | Sum is a type derived in a query based on FieldCombination |
| | for expressing a Sum arithmetic operator. In a case where |
| | operands are disposed in the Sum operator, which means the sum of |
| | all operands. |
| Average | Average is a type derived in a query based on |
| | FieldCombination for expressing an Average arithmetic |
| | operator. In a case where operands are disposed in the |
| | Average operator, which means the average of all operands. |
| Count | Count is a type derived in a query based on |
| | FieldCombination for expressing a Count arithmetic |
| | operator. In a case where operands are disposed in the |
| | Count operator, which means the number of all operands. |
| Max | Max is a type derived in a query based on FieldCombination |
| | for expressing a Max arithmetic operator. In a case where |
| | operands are disposed in the Max operator, which means the |
| | maximum operand of all operands. |
| Min | Min is a type derived in a query based on FieldCombination |
| | for expressing a Min arithmetic operator. In a case where |
| | operands are disposed in the Min operator, which means the |
| | minimum operand of all operands. |
| Add | Add is a type derived in a query based on FieldCombination |
| | for expressing an Add arithmetic operator. In a case where |
| | operands are disposed in the Add operator, which means the |
| | sum of all operands. |
| Multiply | Multiply is a type derived in a query based on |
| | FieldCombination for expressing a Multiply arithmetic |
| | operator. In a case where operands are disposed in the |
| | Multiply operator, which means the multiplication of all operands. |
| Subtract | Subtract is a type derived in a query based on |
| | FieldCombination for expressing a Subtract arithmetic |
| | operator. In a case where operands are disposed in the |
| | Subtract operator, which means the value of a second |
| | operand subtracted from a first operand. |
| Divide | Divide is a type derived in a query based on |
| | FieldCombination for expressing a Divide arithmetic |
| | operator. In a case where operands are disposed in the |
| | Divide operator, which means the quotient of a second |
| | operand divided by a first operand. |
| Modulus | Modulus is a type derived in a query based on |
| | FieldCombination for expressing a Modulus arithmetic |
| | operator. In a case where two operands are disposed in the |
| | Modulus operator, which means the remainder of a second |
| | operand divided by a first operand. |
| Round | Round is a type derived in a query based on |
| | FieldCombination for expressing a Round arithmetic |
| | operator. In a case where one operand are disposed in the |
| | Round operator, which means an integer which is nearest to |
| | an operand. |
| Floor | Floor is a type derived in a query based on FieldCombination |
| | for expressing a Floor arithmetic operator. In a case where |
| | one operand are disposed in the Floor operator, which means |
| | the smallest integer which is nearest to an operand. |
| Ceil | Ceil is a type derived in a query based on FieldCombination |
| | for expressing a Ceil arithmetic operator. In a case where |
| | one operand are disposed in the Ceil operator, which means |
| | the greatest integer which is nearest to an operand. |
| Field | Field expresses operands for each arithmetic operation. |
| FieldCombination | FieldCombination expresses the operands of an intrinsic type |
| | for each arithmetic operation. |
| GroupBy | GroupBy expresses that an operation must be performed after |
| | grouping by a defined specific condition. |

A case will be described below in which the request element field type is added in order to request various content searches through an arithmetic operation or an independent comparison operation in the SOAP query operation.

1. Comparison Operator Type

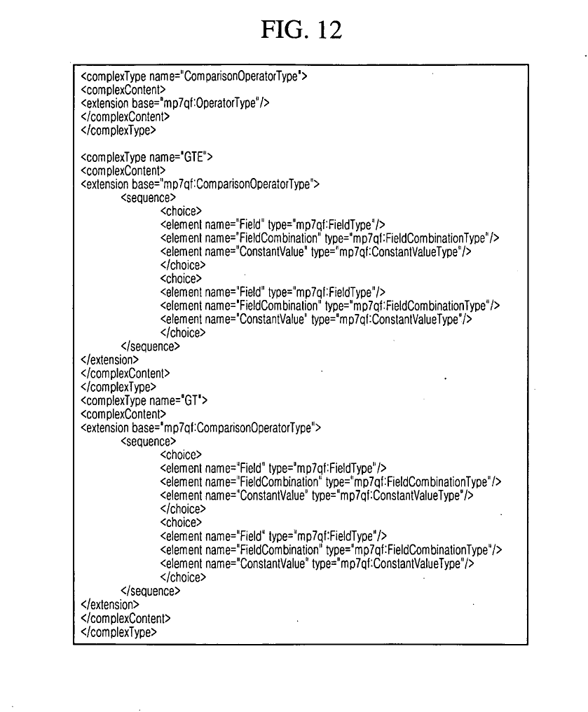

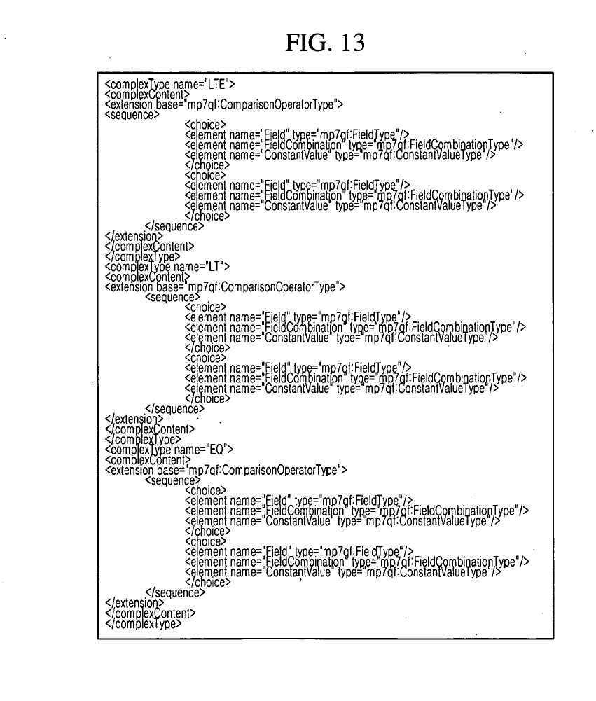

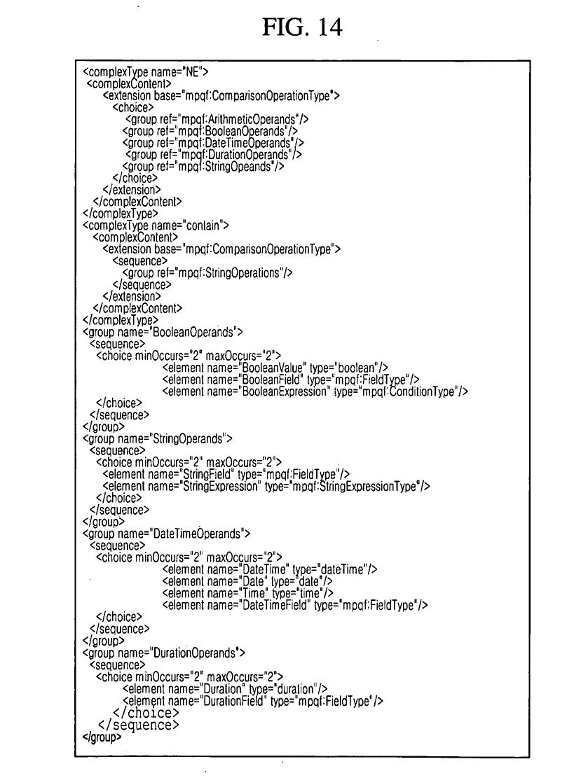

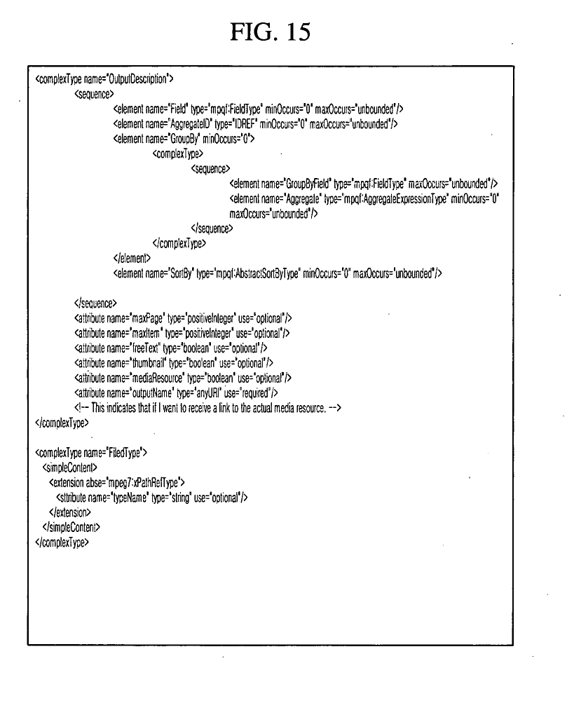

A comparison operator type is defined by extending an operator type, and is an abstract type which is the upper class of all operator types for describing a comparison operation. All comparison operator types must succeed to the comparison operator type as the abstract type. The comparison operators according to an exemplary embodiment must carry a Boolean value as a result. Such a comparison operator type is expressed as illustrated in FIGS. 12 to 14.

The comparison operators of FIGS. 12 to 14 are defined as described in the following Table 3.

The comparison operators of FIGS. 12 to 14 are defined as described in the following Table 3.

TABLE 3

| Name | Definition |
|---|---|
| ComparisonType | ComparisonType is a base type for defining logic operators. |
| GTE | GTE is a class defining a GTE operation in a query based on |
| | ComparisonType. In a case where two operands are disposed |
| | in the GTE operation, a GTE operator means to determine |
| | whether the great or equal relationship between the two operands is |
| | True or False. |
| GT | GT is a class defining a GT operation in a query based on |
| | ComparisonType. In a case where two operands are disposed |
| | in the GT operation, a GT operator means to determine whether |
| | the great relationship between the two operands is True or False. |
| LTE | LTE is a class defining an LTE operation in a query based on |
| | ComparisonType. In a case where two operands are disposed |
| | in the LTE operation, an LTE operator means to determine |
| | whether the little or equal relationship between the two operands |
| | is True or False. |
| LT | LT is a class defining an LT operation in a query based on |
| | ComparisonType. In a case where two operands are disposed |
| | in the LT operation, an LT operator means to determine whether |
| | the little relationship between the two operands is True or False. |
| EQ | EQ is a class defining an EQ operation in a query based on |
| | ComparisonType. In a case where two operands are disposed |
| | in the EQ operation, an EQ operator means to determine whether |
| | the equal relationship between the two operands is True or False. |
| NE | NE is a class defining an NE operation in a query based on |
| | ComparisonType. In a case where two operands are disposed |
| | in the NE operation, an NE operator means to determine whether |
| | the non-equal relationship between the two operands is True or False. |
| Contain | Contain is a class defining a contain operation in a query based |
| | on ComparisonType. The contain operation is an operation |
| | determining whether a string succeeding a preceding string |
| | emerges. Accordingly, a contain operator include two strings. |

The comparison operators such as GTE, GT, LTE, LT, EQ, NE and contain require elements expressing two operands. Moreover, the comparison operators may have an arithmetic constant value limited by the constant value type as an operand. All operations may have the intrinsic operation expression of the field combination type.

A technology will be described in detail below that extracts a query result value corresponding to a table field designated in a query-requesting request field type element by the above-described arithmetic operation and/or comparison operation, and transmits the query result value by the response message of the SOAP operation.

The get_Data operation of the TV-Anytime provides a function that enables clients to search TV-Anytime data on a program or a program group from a server. Examples of functions that a TV-Anytime metadata provider can provide using the get-Data operation are as follows.
Return content referencing data of a CRID using a CRID list.
Return the TV-Anytime metadata of the CRID using the CRID list.
An operation receives a query for a specific metadata attribute (for example, a genre, an actor and the like), and returns a program corresponding to the received query.
Respond to a query of a specific time or a specific channel, and return a corresponding program.

The get_Data operation supports all query types in principle, and provides a wide scope of query on a metadata limitation condition. Such query results are expressed as a plurality of metadata tables. The metadata tables are expressed in an extracted order when there is on specific description condition. However, a method is required that clarifies the extracted order for the readability of users and the efficiency of programs, and an aggregation process method such as GroupBy and SortBy used in an existing database, a web search and the like is required.

Therefore, an exemplary embodiment proposes the aggregation process method for a result of a multimedia search.

A query result type is a type for defining an output description element in an input element, provides a result extracting process through an arithmetic operation and/or a comparison operation, and propose a query search result of a type extended to support various arithmetic operations and sum functions together with a sort function.

Moreover, the response message of the SOAP operation has a GroupBy element and a SortBy element as query results. The GroupBy element expresses an aggregate classification on a query result set. For this, the GroupBy element has a field type being a classification reference as a sub-element. The SortBy element expresses a sort reference.

The response message type of the SOAP operation is expressed as illustrated in FIG. 8, and consists of query result elements defined in the following Table 4.

TABLE 4

| Name | Definition |
|---|---|
| OutputDescription | OutputDescription clarifies a method of expressing |
| | information associated with a selected digital item intended to |
| | transfer in an output result of a multimedia search. A data |
| | path is clarified in each item metadata. |
| maxPage | maxPage expresses a maximum result page. (optional) The |
| | result items of a given query may be distributed between |
| | different result pages. |
| maxItem | maxItem expresses the maximum number of result items. |
| | (optional) |
| freeText | freeText is a Boolean element clarifying whether it is expected |
| | that a FreeText area emerges in each result item. (optional) |
| | When a Boolean element value is False, the FreeText area |
| | must not emerge in the each result item. If the Boolean |
| | element is not clarified, it is assumed that a user is irrelevant to |
| | whether the FreeText area emerges. |
| Resource | Resource is a Boolean element clarifying whether it is |
| | expected that a resource area emerges in each result item. |
| | (optional) When a Boolean element value is False, the |
| | resource area must not emerge in the each result item. If the |
| | Boolean element is not clarified, it is assumed that a user is |
| | irrelevant to whether the resource area emerges. |
| outputName | outputName clarifies the URI of namespace associated with a |
| | metadata type that is expected to emerge in the Description |
| | element of each result item. outputName may be namespace |
| | associated with MPEG-7 or other metadata types. |
| Field | Field clarifies data paths in the metadata of items. The paths |
| | may be expressed as absolute Xpath indicating the root of the |
| | metadata of the items, or may use a relative Xpath expression |
| | indicating a selectively derived type of a MPEG-7 schema. |
| AggregateID | AggregateID is the ID of an operation which a user desires to |
| | receive. |
| FieldCombination | FieldCombination clarifies an arithmetic function or a sum |
| | function that takes a field in the metadata of items. The sum |
| | function and the arithmetic function are defined in the lower |
| | paragraph of an arithmetic operator. |
| SortBy | SortBy clarifies a main field for a sort and an order (an |
| | ascending order or a descending order). |
| GroupBy | GroupBy expresses that an operation must be performed after |
| | grouping by a defined specific condition. |
| GroupByField | GroupByField is a field that becomes a key of a grouping process. |
| Aggregate | Aggregate is the ID of an operation intended to be applied to a |
| | result of a specific grouping operation by a user. |
| Thumbnail | Thumbnail expresses whether a preview function is used as a |
| | Boolean. |
| typeName | A name of a schema of MPEG-7 or other metadata type is |
| | specified. typeName is expressed as a relative path of Xpath. |

The present disclosure sorts and/or groups the query results of contents according to the extraction order of queried contents by adding operators associated with an arithmetic operation and/or a comparison operation to a query request field of a SOAP query operation upon query request of contents, thereby servicing the more various accurate query results of contents. Accordingly, the present disclosure services the more various accurate query results of contents on the basis of user's preference information to users, thereby increasing convenience for users.

As described above, the present disclosure sorts and/or groups the query results of contents according to the extraction order of queried contents by adding operators associated with an arithmetic operation and/or a comparison operation to a query request field of a SOAP query operation upon query request of contents, thereby servicing the more various accurate query results of contents. Accordingly, the present disclosure services the more various accurate query results of contents on the basis of users?preference information to users, thereby increasing convenience for users.

What is claimed is:

1. A method for servicing search content by a Simple Object Access Protocol (SOAP) operation, the method comprising:
transmitting a request message of a SOAP query operation to which a request element field type is added in order to request various content searches through a complex operation; and
extracting a query result expression value corresponding to a table field designated in the request field type element, and adding the extracted query expression value to a query result element to transmit the added value by a response message of the SOAP operation, when the request message comprises the request element field type designating a query request result value.

2. The method of claim 1, wherein the response message comprises at least one query result element of maxPage, maxItem, freeText, resource, outputName, Field, AggregateID, FieldCombination, SortBy, GroupBy, GroupByField, Aggregate, Thumbnail and typeName.

3. The method of claim 1, wherein the response message sorts and/or groups query results according to query-requesting contents.

4. The method of claim 1, wherein the response message is defined as follows
```
<complexType name=“OutputDescription”>
    <sequence>
        <element name=“Field” type=“mpqf:FieldType” minOccurs=“0”
maxOccurs=“unbounded”/>
        <element name=“AggregateID” type=“IDREF” minOccurs=“0”
maxOccurs=“unbounded”/>
        <element name=“GroupBy” minOccurs=“0”>
<complexType>
        <sequence>
        <element name=“GroupByField” type=“mpqf:FieldType”
maxOccurs=“unbounded”/>
        <element name=“Aggregate”
type=“mpqf:AggregateExpressionType” minOccurs=“0”
maxOccurs=“unbounded”/>
        </sequence>
        </complexType>
        </element>
        <element name=“SortBy” type=“mpqf:AbstractSortByType”
minOccurs=“0” maxOccurs=“unbounded”/>
        </sequence>
        <attribute name=“maxPage” type=“positiveInteger”
        use=“optional”/>
        <attribute name=“maxItem” type=“positiveInteger”
        use=“optional”/>
        <attribute name=“freeText” type=“boolean” use=“optional”/>
        <attribute name=“thumbnail” type=“boolean” use=“optional”/>
        <attribute name=“mediaResource” type=“boolean”
        use=“optional”/>
        <attribute name=“outputName” type=“anyURI”
        use=“required”/>
        <!-- This indicates that if I want to receive a link to the
actual media resource. -->
</complexType>
<complexType name=“FiledType”>
  <simpleContent>
    <extension abse=“mpeg7:xPathRefType”>
      <sttribute name=“typeName” type=“string” use=“optional”/>
    </extension>
  </simpleContent>
</complexType>
```

5. The method of claim 1, wherein the complex operation is a specific operation which enables to express a query result by expressing a high-level query contents.

6. The method of claim 1, wherein the complex operation is an arithmetic operation and/or a comparison operation.

7. A computer-readable storage medium storing a command which performs each operation of a method for servicing search content by a Simple Object Access Protocol (SOAP) operation, comprising instructions to:
transmit a request message of a SOAP query operation to which a request element field type is added in order to request various content searches through a complex operation; and
extract a query result expression value corresponding to a table field designated in the request field type element, and adding the extracted query expression value to a query result element to transmit the added value by a response message of the SOAP operation, when the request message comprises the request element field type designating a query request result value.
